(19) United States
(12) Patent Application Publication
(10) Pub. No.: US 2010/0235205 A1
(43) Pub. Date: Sep. 16, 2010

(54) METHOD OF ENSURING SAFETY OF FOOD PRODUCTS

(76) Inventor: Brian David Long, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/405,131

(22) Filed: Mar. 16, 2009

(51) Int. Cl. G06Q 90/00; G06F 17/30; G06Q 10/00; G06Q 50/00

(52) U.S. Cl. 705/7; 705/500; 707/E17.044

(57) ABSTRACT

A method is disclosed comprising: assigning a unique batch number to a batch of food processed in a processing facility; obtaining a first sample and a second sample from the batch of food and storing at least the second sample; testing the first sample with a safety test to obtain a first test result; making the first test result available in association with the unique batch number to a downstream user who receives from the processing facility food from the batch of food in association with the unique batch number; upon receipt of a request to verify the first test result in the event that the first test result indicates an unsafe risk to a final consumer of the food, testing the second sample with the safety test to obtain a second test result, and making the second test result available in association with the unique batch number to the downstream user; and disposing of the food if the second test result also indicates an unsafe risk to the final consumer.

### TECHNICAL FIELD

This document relates to methods ensuring the safety of food products in a food supply chain.

### BACKGROUND

The frequency and severity of recalls provide a reliable indication of the level of a country's food safety. Public confidence in the Canadian food supply chain has been damaged by recent tragic recalls. Current food safety is predicated on the theory that each processor is under similar tightly controlled HACCP programs, so it's assumed all products are safe to use, but this is not necessarily true. In general, it isn't incumbent or practical for resellers or secondary processors to make microbial tests on products received from other processors, prior to sale to further distribution or sale to the public. The current food supply system doesn't trigger recalls until after problems arise, which is usually too late. Recent Government Inspection regulations call for the testing of food contact surfaces once a week for listeria, and actual food samples only 12 times a year, with test results being reported to the CFIA by the processor. These results may lead to product recalls if tests indicate dangerous levels of pathogens, but with the ensuing time delay the products will have been in the food distribution channels for some time and many will have already been consumed by the public. Further, the Canadian Food Inspection Agency issues public notices on their website, but usually the best-before dates involved show that the products have been available to the public for several weeks already. This means that the recall has been made much too late as most of the product has already been consumed, and the damage already done.

Recalls can be prevented if bacteriological problems are identified prior to distribution, instead of after they have entered the retail distribution chain. A new system is needed to provide ongoing proof of quality and absence of pathogens to retailers and further processors in a more efficient and cost-effective manner than prior systems.

### SUMMARY

A method is disclosed comprising: assigning a unique batch number to a batch of food processed in a processing facility; obtaining a first sample and a second sample from the batch of food and storing at least the second sample; testing the first sample with a safety test to obtain a first test result; making the first test result available in association with the unique batch number to a downstream user who receives from the processing facility food from the batch of food in association with the unique batch number; upon receipt of a request to verify the first test result in the event that the first test result indicates an unsafe risk to a final consumer of the food, testing the second sample with the safety test to obtain a second test result, and making the second test result available in association with the unique batch number to the downstream user; and disposing of the food if the second test result also indicates an unsafe risk to the final consumer.

Another method is disclosed comprising: receiving a unique batch number and a first test result, the unique batch number assigned to a batch of food processed in a processing facility and the first test result obtained from a safety test performed on a first sample of the batch of food, in which a second sample of the batch of food has been stored; making the first test result available, in association with the unique batch number, in a database to a downstream user who receives from the processing facility food from the batch of food in association with the unique batch number; receiving a second test result obtained from a safety test carried out on the second sample in the event that the first test result indicates a safety risk to a final consumer of the food; and making the second test result available, in association with the unique batch number, in the database to the downstream user.

Another method is disclosed comprising: assigning a unique batch number to a batch of food processed in a processing facility; obtaining a first sample and a second sample from the batch of food and storing at least the second sample; having a safety test performed on the first sample to obtain a first test result; making the first test result available in association with the unique batch number to a downstream user who receives from the processing facility food from the batch of food in association with the unique batch number; in the event that the first test result indicates a safety risk to a final consumer of the food, having the safety test performed on the second sample to obtain a second test result; making the second test result available in association with the unique batch number to the downstream user; and having the food disposed of if the second test result indicates an unsafe risk to the final consumer.

Another method is disclosed, comprising: assigning a unique batch number to a batch of food processed in a processing facility; obtaining a first sample from the batch of food; testing the first sample with a safety test to obtain a first test result; making the first test result available in association with the unique batch number to a downstream user who receives from the processing facility food from the batch of food in association with the unique batch number, in which the downstream user is at least one of a processor and retailer of the food from the batch of food.

In some embodiments, disclosed is a cost neutral system specifically designed to prevent pathogens in food products from entering the food supply chain requiring public recalls. In an embodiment, a customized host-based communication system is disclosed designed to share bacteriological test data linking for example meat and dairy processors, secondary processors and retailers instantaneously with the objective of removing unsafe products before such products reach retail stores or the end consumer. This may involve the generation of unique product batch codes, testing laboratories and a secure internet database with upload, download and billing capabilities able to carry advertising messages with an overall objective to improve food safety by eliminating products including entire production runs which have been tested and proven to contain harmful pathogens or bacteria. Retailers and secondary processors are able to check the host data base for test results of products from a producer immediately after receipt of a specially assigned product batch code (PBC) which arrives with the product from a processor. For example: processor A assigns a special code supplied by the host database to identify critical information about the production run. Samples are taken from the run using the PBC as identification and (a) retained as control samples and (b) sent to lab for analyses. The outer packaging of the product, invoice and/or waybill may be marked with the PBC and the product shipped to retailers or secondary processors. Results of the tests are uploaded to the host database, which make the results available to the holders of the PBC codes who are screened and logged in to the server. If the results are deemed acceptable, distribution/secondary processing may continue normally. If deemed unacceptable, distribution/processing may be halted and the control sample tested to confirm results. The entire batch may be shipped back to the original processor upon receiving unacceptable results.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a schematic illustrating a supply chain.

FIG. 2 is a schematic illustrating a further supply chain.

FIG. 3 is a flow chart illustrating a method according to some of the embodiments disclosed herein.

FIG. 4 is a flow chart illustrating another method according to some of the embodiments disclosed herein.

FIG. 5 is a flow chart illustrating a further method according to some of the embodiments disclosed herein.

FIG. 6 is a flow chart illustrating a further method according to some of the embodiments disclosed herein.

### DETAILED DESCRIPTION

Immaterial modifications may be made to the embodiments described here without departing from what is covered by the claims. Directional arrows in the figures may indicate the flow of at least one of information and product.

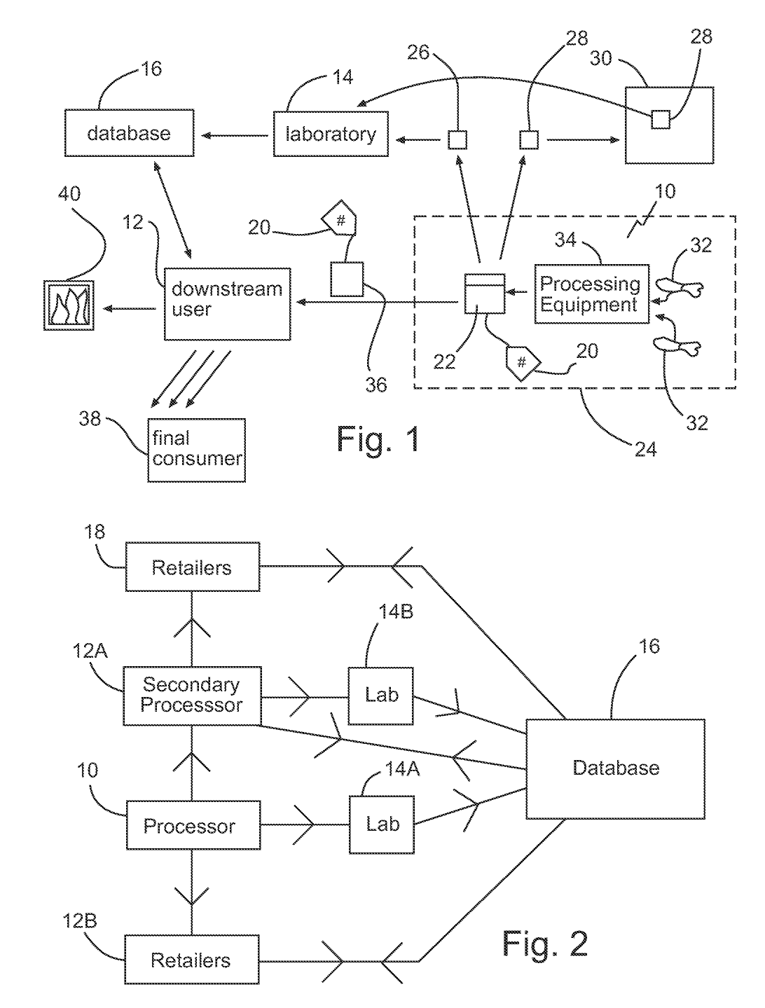

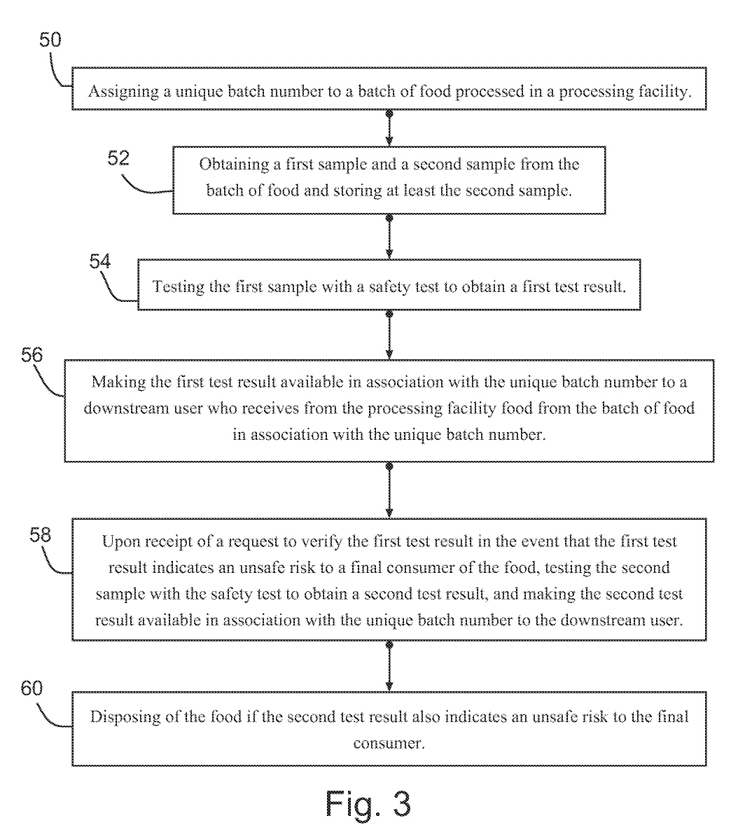

Referring to FIG. 3, a method is illustrated. Referring to FIG. 1, in a stage 50 (shown in FIG. 3), a unique batch number 20 is assigned to a batch of food 22 processed by a processor 10 in for example a processing facility 24. Batch of food 22 originates from food 32 that is then processed in for example processing equipment 34 in facility 24, and may include for example meat, cheese, dairy, and other suitable food types. The batch of food includes for example all the food produced using certain processing equipment 34 over the span of a day, week, or longer, or in a single production run, and may include all the food produced in the entire facility 24 over the selected time period. In some embodiments, the food selected to be identified as part of the batch of food 22 includes food processed in such a way that contaminants present on an item of food in the batch may potentially and realistically contaminate an entire volume of food. The unique batch number 20, which may be a batch code, may be provided for example on at least one of the packaging of the food 36, the waybillibill of landing sent with the food 36, and other sorts of communication sent to the downstream user 12 in association with food 36. The number 20 may be used in addition to, or instead of, a regular UPC, and may be labeled on for example exterior packaging, containers, invoices, masters and combos. The number 20 may be incorporated into the billing system or shipping forms of the processor 24. The batch number is unique to each batch of food 20 processed in the facility 24, in order to prevent confusion with other batches of food from facility 24 or other facilities. The unique batch number may include other information, related to for example company details, plant details, food details, production details, for example the production line used for the batch, and the time & date of the run, and optional pre-op details such as inspection summaries. Inventory control may be used to automatically add the product batch code to existing product identification codes.

In a stage 52, at least one first sample 26 and at least one second sample 28 are obtained from the batch of food 22 and at least the second sample 28 is stored, for example in a storage unit 30, for further example a freezing unit. Batch samples may be handled with HACCP principals. Storage may be carried out for example on-site, by a laboratory (14), or by another entity, and more than one of each sample may be taken. Storage may be accomplished in such a way that preserves the testable quality of the sample to remain representative of the testable quality of food 36, so that testing second sample 28 at a later point in time will provide relevant feedback on the quality of food 36.

In a stage 54, first sample 26 is tested, for example by laboratory 14, which may be for example an in-house or out-house independent facility, with a safety test to obtain a first test result. Laboratory 14 may receive batch coded samples from processors with orders for the applicable tests. In some embodiments the laboratory 14 deals only with at least one of the processor 24 and the database 16, having no direct contact with downstream user 12, in order to reduce allegations of bias. In some embodiments, plural first samples are taken, for testing with for example at least one safety test, for example at least one test or series of test being selected by the downstream user 12. The safety test may include a suitable test for example tests for microbial quality such as aerobic plate count, coliforms, yeast& mold, staphylococci, salmonella, and e.coli, tests for food pathogens such as salmonella, lysteria monocytogenes, e.coli 0157:h7, and other tests such as tests for allergenic substances for example a test for peanut residue in chocolate. Other suitable tests include suitable types of tests for contamination, infection, adulteration, disease, and unsafe condition of the food. Exemplary test results include positive/negative indications, numerical values and ranges, acceptable/unacceptable, and may be accompanied by for example specifications of the test for example time, conditions, details, and date of the tests. Test results that exceed or fail to reach predetermined thresholds may be indicative of a health risk to final consumer 38 depending on the nature of the test.

In a stage 56, the first test result is made available in association with the unique batch number 20, for example in a database 16, which may be for example provided via an internet web site, to downstream user 12 who receives, for example directly or indirectly through another facility, from the processing facility 24 food 36 from the batch of food 22 in association with the unique batch number 20.

In this way, the downstream user 12 has access to the test results, which may contain proof of contamination or non contamination, enabling the downstream user to make an informed decision on whether to continue normally or regard the shipment as questionable or unusable. This is efficient because it can prevent a larger scale recall of contaminated product at a later date. An advantage in using an internet system for conveying or providing access to the test results is that the results may be obtained by the downstream user, for example upon request, almost instantaneously upon upload from the laboratory 14. Any request made may contain the unique batch number. This instant transfer of microbial test data is crucial to the “just in time” inventory management schedules of typical downstream users in the perishable food industry. Further, this system allows product testing to take place immediately after production while the products are for example still in transit or in cold storage awaiting shipping. In some embodiments, the first sample(s) is tested as soon as possible after being taken. For a downsteam user, quality control may be simplified somewhat to monitoring the host website for lab results. In some embodiments, the downstream user refrains from using the food prior to receipt of the first test result.

The test results may be made available to the at least one downstream user 12 in a confidential manner, for example by requiring downstream user 12 to use at least one of a password and other information such as the product batch code to access the test results. For example, upon receipt of food 36, downstream user 12 may log onto the database 16 website in order to view and download the test results. The password may be supplied in association with the food 36 itself. In some embodiments the password is unique to the downstream user 12. Confidentiality may be further maintained between for example laboratories, processors and retailers. Referring to FIG. 2, this also allows multiple downstream users 12A and 12B to confirm the quality of the same batch of food, regardless of the destination. In some embodiments the test results are sent by secure transmission to the downstream user 12.

In the event that the first test result(s) appear safe, use, for example at least one of production, distribution, and sale, may be continued by the downstream user. However, in the event that the first test result indicates an unsafe risk to a final consumer 38 of the food, in a stage 58 the second sample 28 is tested with the safety test, for example by at least one of laboratory 14 and a different laboratory, to obtain a second test result, and the second test result is made available, for example in the same manner as the first test result, in association with the unique batch number to the downstream user. The existence of an unacceptable test result at a stage may trigger an alert, which may be sent to for example at least one of the downstream user 12, the processor 24, the laboratory 14, client supervisory personnel, storage unit 30, and another other relevant entity, for example an entity responsible for, or related to, one of the previously listed entities. The alert/warning may be automatic, and may be sent using for example at least one of cell phone, land line, VOIP, text, Blackberry, SMS, and email, by for example at least one of the database 16, the laboratory 14, and any other relevant entity. This way, an unacceptable test result may be actively brought to the attention of the relevant party. By doing so, corrective steps may be taken immediately, for example a hold may be triggered on the shipment, and the testing of the second sample may be initiated. The second sample 28 (the control sample) is used as confirmation of the unacceptable state of the food 36 in the event of a questionable test result. This is important in that it allows an unacceptable test result to be confirmed prior to removing batch of food 22 from the supply chain permanently. Stage 58 is carried out upon receipt of a request, for example from at least one of the downstream user 12, the laboratory 14, database 16, and processing facility 24, to verify the first test result in the event that the first test result indicates an unsafe risk to a final consumer 38 of food from the batch of food 22. The request may be automatic. Verification may be requested upon receipt by the downstream user of the first test result.

Upon receipt of an indication from the first test result that the food indicates an unsafe risk to the final consumer 38 of the food, for example in the event of test results positive for dangerous listeria levels, use of the food by the downstream user may be at least suspended, stopped, and prevented. Use may be resumed if the second test result indicates that the food 26 is safe to use.

In a stage 60, in the event that the second test result also indicates an unsafe risk to the final consumer 38, the food 36 is disposed of. An example of disposal is a method of preventing the food 36, by the downstream user 12, from being further produced and distributed for consumption, and includes dealing with the food 36 outside of the normal production stream. For further example, downstream users may reject deliveries of products that have failed the safety test(s), and in general a downstream user may develop its own policy in this regard. Disposal may also be accomplished by for example burning in incinerator 40 or shipment back to the processing facility 24. On the other hand, if the second test result does not indicate an unsafe risk, the food may be used or continued to be used by the downstream user.

The methods disclosed herein are not an attempt to track food products from hoof to platter, but to isolate the points where bacterial contamination may occur and provide a processor with a mechanism to guarantee and document to a downstream user in real time that contamination has not occurred to the product they have just received or shipped. A downstream user 12 is defined as a company or individual to which the food 36 is shipped, and may include a retailer who simply places the product on display for resale to the public.

Database 16 may be run on a subscriber basis, with downstream users 12 subscribing individually to receive test results, and processors 24 subscribing to have their products test results made available. The database 16 may be financed by for example sign-up and/or monthly fees, and advertising.

Referring to FIG. 2, an exemplary embodiment is illustrated with plural downstream users 12A, B, and plural laboratories 14A,B. Processor 10 transports food 36 (shown in FIG. 1) to downstream users, for example a secondary processor (downstream user 12A) and a retailer (downstream user 12B), while first samples are sent to laboratory 14A for testing. Laboratory 14A in turn sends the first test result(s) to database 16, where the test results are made available to both downstream users 12A, B.

For secondary processors, for example downstream user 12A, the methods disclosed herein may be repeated with the secondary processor now considered the initial processor. Thus, for food 36 that is further processed by user 12A, new unique batch numbers may be generated for a new batch of food that comprises food 36 from the original batch of food 22. Subsequent batch codes may retain association with information related to the initial product batch code, for example a subsequent batch code may have the initial batch code appended to it. Examples of secondary processing include packaging, repackaging, cooking, seasoning, and assembling multiple food items into a single salable item. Samples are sent to a laboratory, for example laboratory 14B, and a further downstream user, for example retailer 18 may access the first and second test results from the database, for example database 16 as before. Multiple databases may be used for this purpose, or the same may be used as illustrated. Each time the food is exposed through processing by a facility it may become contaminated by various types of bacteria and/or harmful substances.

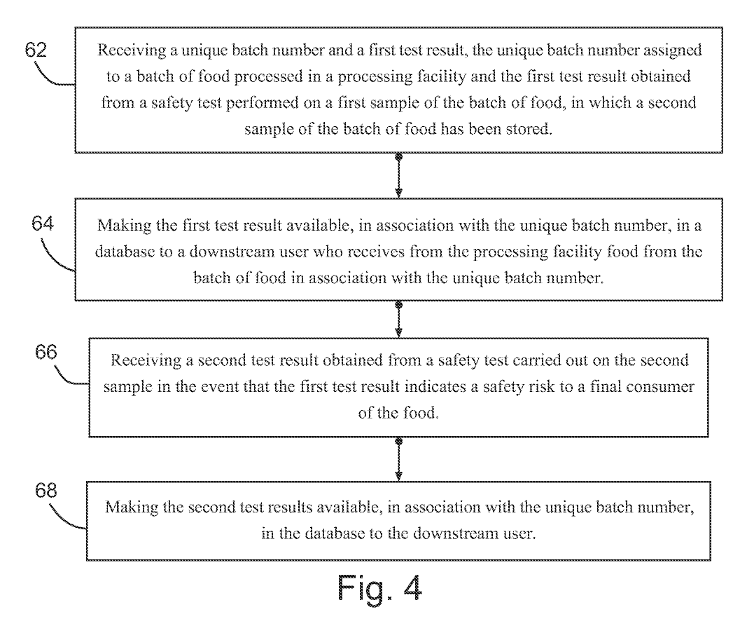

Referring to FIG. 4, a further method is illustrated, for example from the point of view of an entity, for example a database manager of database 16 (shown in FIG. 1), that is responsible for receiving and making available the test results. This method may be carried out similarly to the other methods disclosed herein. Referring to FIG. 1, in a stage 62, a unique batch number and a first test result are received by for example database 16, the unique batch number and first test result being acquired according to the methods disclosed herein. A second sample 28 has also been stored. In a stage 64, the first test result is made available, in association with the unique batch number, in a database 16 to a downstream user (for example user 12) who receives from the processing facility 24 food, for example food 36.

As above, in the event that the first test result indicates a safety risk to a final consumer (for example consumer 38) of the food 36, in a stage 66 a second test result obtained from a safety test carried out on the second sample 28 is received, for example by database 16. As before, the second test result may be obtained upon receipt, for example by the database 16, of a request for verification of the first test result. The database 16 may request that the second test result be obtained, by for example instructing laboratory 14. In a stage 68, the second test result is also made available, in association with the unique batch number, in the database 16 to the downstream user 12. The database 16 may be stored on a computer readable medium (illustrated for example as database 16). Referring to FIG. 2, the provision of this service allows multiple laboratories 14A,B and multiple downstream users 12A,B, 18, to communicate with database 16 to receive test results on the quality of food 36.

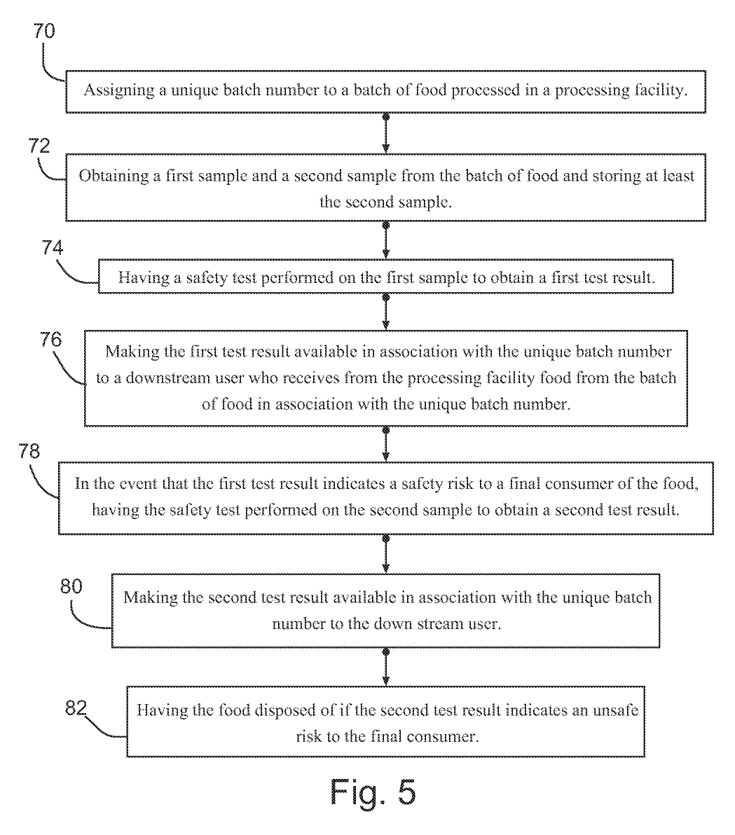

Referring to FIG. 5, a further method is illustrated, for example from the point of view of an entity, for example processing facility 24 (shown in FIG. 1), that produces batch of food 22. This method may be carried out similarly to the other methods disclosed herein. Referring to FIG. 1, in a stage 70, a unique batch number 20 is assigned to a batch of food 22 processed in a processing facility 24. Custom database software may be used for this purpose to generate hundreds of thousands of unique batch numbers. In a stage 72, a first sample 26 and a second sample 28 are obtained from the batch of food 22, and at least the second sample 28 is stored. In a stage 74, a safety test is performed, for example by laboratory 14, on the first sample 26 to obtain a first test result. In a stage 76, the first test result is made available in association with the unique batch number 20 to a downstream user 12 who receives from the processing facility 24 food from the batch of food 22 in association with the unique batch number 20. This stage may be accomplished through another entity, for example by instructing database 16 to make the test results available to the downstream user.

In a stage 78, in the event that the first test result indicates a safety risk to a final consumer 38 of the food, the safety test is performed on the second sample 28 to obtain a second test result. This stage may be accomplished for example by instructing laboratory 14 to test the second sample 28. In a stage 80, the second test result is made available in association with the unique batch number 20 to the downstream user 12. Again, this may be done through another entity, for example database 16. In a stage 82, if the second test result indicates an unsafe risk to the final consumer 38, the food is disposed of. Again, this may be orchestrated through another entity, for example by instructions to dispose or return the food 36 for example. Products returned to the processor may be further analysed, and potentially re-entered into the food chain in certain situations. Although each of the stages 78-82 may be carried out by entities other than the processing facility, by entering into an agreement or policy to have these stages carried out directly or indirectly, the processing facility 24 is effectively orchestrating the disclosed method.

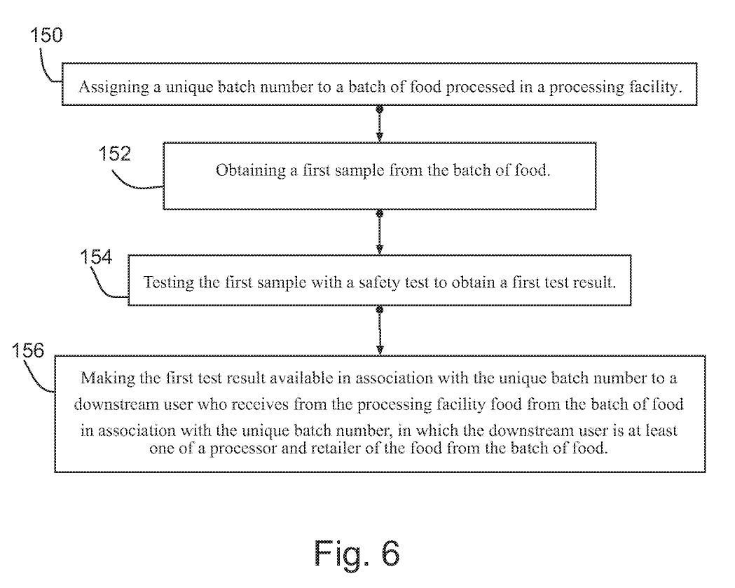

Referring to FIG. 6, a further method is illustrated. Stages 150, 152, and 154 are carried out in a similar manner as respective stages 50, 52, and 54 of FIG. 3, with the exception that in stage 152 there is no requirement to take a second sample. In a stage 156, the first test result is made available in association with the unique batch number 20 to a downstream user 12 who receives from the processing facility 10 food 36 from the batch of food 22 in association with the unique batch number 20, in which the downstream user 12 is at least one of a processor and retailer of the food 36 from the batch of food 22. This way, a downstream user who is not a final consumer, but who at least one of processes, packages, and distributes food from the batch of food 22 in some way, has access to the test results, and can proceed in a similar manner as the methods disclosed herein upon receipt of those test results. This compartmentalization of a food processing system is efficient and ensures that contaminated food does not pass further than for example one step through the system before being removed from production.

The methods disclosed herein have the potential for numerous beneficial improvements over existing systems. Increased confidence may be gained by the public in the quality and safety of the food supply chain, as healthier, safer food products of higher value are produced. In addition, food on sale will carry a lower health risk for the aged. The combined effects will result in a reduced number of hospitalizations and deaths from food-quality-related illnesses, thus reducing the cost of public health institutions. In addition, for retailers and downstream users, reduced liability and risk will be experienced. In turn, the insurance industry will experience lower insured risks and increased profits. For processors and other entities in the supply chain, higher company values, stock prices, investor and consumer confidence, public image, public trust, and sales will be experienced as costly recalls are reduced and avoided.

The methods disclosed herein provide simple and cost effective ways of ensuring food safety, without requiring the installation of extensive monitoring and tracking systems/infrastructure. In fact, in one embodiment, the database may be set up completely independent of the processor or downstream user. These methods are advantageous over previous systems in that the distribution/production chain of food products is compartmentalized down to input and output points of each processing facility, with food quality being asserted at each level in an efficient manner prior to the food continuing to the next level. This allows the spread of contaminated food to be controlled and restrained at or near after the point of contamination, and certainly before dissemination to the public. This is an improvement over prior systems that merely track the progress of contaminated food in order to trace the location of all possible contaminated food for removal from the system when contamination is detected. Throughout the processes disclosed herein, the product batch code may be used for identification of the food 36.

In some embodiments, speed of at least one of testing and reporting of test results is employed. The use of the internet is advantageous for achieving both purposes, as it allows users of these systems to have immediate transmission of testing-related communications, for example test results to the relevant parties. The internet is extremely useful for this purpose, as it bridges the geographical, personnel, and organizational barriers required to achieve efficient and effective communication between producers and downstream users. This aids in ensuring that tainted products are removed prior to receipt by consumers, and provides advantages over current CFIA procedures.

Use of the methods disclosed herein does not preclude the use of generally accepted and/or mandatory food safety methods and procedures that may be employed in a facility. Examples of such methods and procedures include for example HACCP procedures and Government Regulations regarding sanitation and bacterial testing.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A method comprising:
assigning a unique batch number to a batch of food processed in a processing facility;
obtaining a first sample and a second sample from the batch of food and storing at least the second sample;
testing the first sample with a safety test to obtain a first test result;
making the first test result available in association with the unique batch number to a downstream user who receives from the processing facility food from the batch of food in association with the unique batch number;
upon receipt of a request to verify the first test result in the event that the first test result indicates an unsafe risk to a final consumer of the food, testing the second sample with the safety test to obtain a second test result, and making the second test result available in association with the unique batch number to the downstream user; and
disposing of the food if the second test result also indicates an unsafe risk to the final consumer.

2. The method of claim 1 in which at least the first test result is made available, in association with the unique batch number, in a database.

3. The method of claim 1 in which at least the first test result is made available through an internet web site.

4. The method of claim 1 in which verification is requested by the downstream user upon receipt by the downstream user of the first test result.

5. The method of claim 1 further comprising at least suspending use of the food by the downstream user if the first test result indicates an unsafe risk to the final consumer.

6. The method of claim 5 further comprising using the food by the downstream user in the event that the second test result does not indicate an unsafe risk.

7. The method of claim 1 in which the batch of food comprises meat.

8. The method of claim 1 in which the safety test comprises at least one test selected by the downstream user.

9. The method of claim 1 in which the downstream user refrains from using the food prior to receipt by the downstream user of the first test result.

10. The method of claim 1 in which making the first test result available further comprises supplying the first test result to the downstream user upon receipt of a request from the downstream user to access the first test result, the request containing the unique batch number.

11. A method comprising:
receiving a unique batch number and a first test result, the unique batch number assigned to a batch of food processed in a processing facility and the first test result obtained from a safety test performed on a first sample of the batch of food, in which a second sample of the batch of food has been stored;
making the first test result available, in association with the unique batch number, in a database to a downstream user who receives from the processing facility food from the batch of food in association with the unique batch number;
receiving a second test result obtained from a safety test carried out on the second sample in the event that the first test result indicates a safety risk to a final consumer of the food; and
making the second test result available, in association with the unique batch number, in the database to the downstream user.

12. The method of claim 11 further comprising having the food disposed of if the second test result indicates an unsafe risk to the final consumer.

13. The method of claim 11 in which the first test result and the second test result, in the database, are made available through an internet website.

14. The method of claim 11 in which the database is stored on a computer readable medium.

15. The method of claim 11 in which the second test result is obtained upon receipt of a request for verification of the first test result.

16. A method comprising:
assigning a unique batch number to a batch of food processed in a processing facility;
obtaining a first sample and a second sample from the batch of food and storing at least the second sample;
having a safety test performed on the first sample to obtain a first test result;
making the first test result available in association with the unique batch number to a downstream user who receives from the processing facility food from the batch of food in association with the unique batch number;
in the event that the first test result indicates a safety risk to a final consumer of the food, having the safety test performed on the second sample to obtain a second test result;
making the second test result available in association with the unique batch number to the downstream user; and
having the food disposed of if the second test result indicates an unsafe risk to the final consumer.

17. A method comprising:
assigning a unique batch number to a batch of food processed in a processing facility;
obtaining a first sample from the batch of food;
testing the first sample with a safety test to obtain a first test result;
making the first test result available in association with the unique batch number to a downstream user who receives from the processing facility food from the batch of food in association with the unique batch number, in which the downstream user is at least one of a processor and retailer of the food from the batch of food.
